(19) United States
(12) Patent Application Publication
(10) Pub. No.: US 2023/0240301 A1
(43) Pub. Date: Aug. 3, 2023

(54) PROTECTIVE FILM WITH ANTIBACTERIAL PROPERTY, METHOD FOR PREPARING THE SAME, AND PRODUCT HAVING THE SAME

(71) Applicant: CLOUD NETWORK TECHNOLOGY SINGAPORE PTE. LTD., Singapore (SG)

(72) Inventors: CHIA-HUNG YANG, New Taipei (TW); TIEN-HSIEN WANG, New Taipei (TW); WEI-HSIANG LIU, New Taipei (TW); CHING-FU HSIEH, New Taipei (TW)

(21) Appl. No.: 17/720,440

(22) Filed: Apr. 14, 2022

(30) Foreign Application Priority Data
Jan. 28, 2022 (CN) 202210105226.2

(51) Int. Cl. A01N 59/16; A01N 25/10; A01N 25/34

(52) U.S. Cl. CPC A01N 59/16; A01N 25/10; A01N 25/34

(57) ABSTRACT

A protective film with an antibacterial property for manufactured products and for constantly-handled objects and equipment is formed by solidifying a water-based slurry. The water-based slurry includes 60 parts to 80 parts by weight of a water-based polyurethane, 1 part to 1.5 parts by weight of a dispersant, 1 part to 10 parts by weight of an antibacterial agent, 0.5 parts by weight of a defoamer, and 9 parts to 32 parts by weight of water. The protective film can be sprayed, applied in a dip, or brushed-on, having good adhesion to a surface but is peelable.

### FIELD

The subject matter relates to health and safety, and more particularly, to a protective film with an antibacterial property, a method for preparing the protective film, and a product having the protective film.

### BACKGROUND

Protective films are applied on objects, such as furniture, metal, glass, ceramics, wood products, or plastics, to avoid scratches or dirt adhering. The protective film can also be peeled off from the object to expose the surface of the object. However, such protective film does not have any antibacterial property, and its composition may include organic solvents, which are harmful to human health and the environment.

### BRIEF DESCRIPTION OF THE DRAWINGS

Implementations of the present disclosure will now be described, by way of embodiments only, with reference to the attached figure.

FIG. 1 is a flow chart of a method for preparing a protective film according to an embodiment of the present disclosure.

FIG. 2 is a diagrammatic view of a product including the protective film according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the comparative examples of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

A protective film with an antibacterial property is provided according to an embodiment of the present disclosure. The protective film can be used in factories, public facilities, medical devices, and vehicles.

The protective film is made of a water-based slurry. The water-based slurry includes 60 parts to 80 parts of a water-based polyurethane by weight, 1 part to 1.5 parts of a dispersant by weight, 1 part to 10 parts of an antibacterial agent by weight, 0.5 parts of a defoamer by weight, and 9 parts to 32 parts of water by weight.

In an embodiment, the water-based slurry includes 70 parts of the water-based polyurethane by weight, 1 part of the dispersant by weight, 1 part of the antibacterial agent by weight, 0.5 part of the defoamer by weight, and 27.5 parts of the water by weight. In another embodiment, the water-based slurry includes 80 parts of the water-based polyurethane by weight, 1.5 parts of the dispersant by weight, 9 parts of the antibacterial agent by weight, 0.5 part of the defoamer by weight, and 9 parts of the water by weight.

The water-based polyurethane is a water-based dispersion of anionic aliphatic water-based polyurethane. The water-based polyurethane is prepared from raw materials including methylene diphenyl diisocyanate (MDI, whose chemical formula is C₁₅H₁₀N₂O₂) and polyether polyol. The above raw materials do not lead to an early crosslinking or a gelation. Thus, the water-based polyurethane has a certain viscosity, so that the water-based slurry has firm-forming property after solidification, and the protective film formed by the water-based slurry is peelable. In addition, hard chain segments from the diphenylmethane diisocyanate and soft chain segments from the polyether polyol are covalently coupled with each other, which inhibits the fluidity of chain segments. Thus, the protective film has improved mechanical properties (strong in tension).

In some embodiments, a relative molecular weight of the water-based polyurethane is 10000 to 30000. A solid content of the water-based polyurethane is 30% to 50%. The viscosity of the water-based polyurethane at 25° C. is 10 mPa·s to 200 mPa·s. A pH value of the water-based polyurethane is 8.

The antibacterial agent is a water-based dispersion of nano-sized zinc oxide particles (ZnO). The zinc oxide particles increase the antibacterial property of the protective film. When zinc oxide particles are in contact with bacteria, zinc ions (Zn²⁺), which have strong redox characteristics, react with carboxyl (—COOH), hydroxyl (—OH), and phosphate radical (PO₃²⁻) of phospholipid membranes. Thus, the zinc oxide particles destroy the cell membranes of bacteria and enter the cells. Then, the zinc oxide particles further destroy the enzyme (functional protein) of the electron transport system, and also react with sulfhydryl (— SH, disulfide bonds —Cys—S—S—Cys of the cysteine side chain in the enzyme protein sequence). Thus, the active center of the enzyme is inactivated, so as to achieve sterilization. The reaction mechanism is as follows:

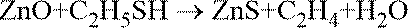

In addition, the zinc oxide particles have a binder compatible chain, which forms steric hindrance to avoid agglomeration of the zinc oxide particles. The zinc oxide particles are also compatible with the water-based polyurethane. The zinc oxide particles further enhance the wear resistance of the protective film.

In some embodiments, in the water-based dispersion of zinc oxide particles, a concentration of the zinc oxide particles is 25000 ppm. An average particle size of the zinc oxide particles is 5 nm to 10 nm.

In some embodiments, the dispersant is sodium hexametaphosphate.

In some embodiments, the defoamer is polyether modified silicone oil.

The protective film of the present disclosure uses the water-based polyurethane as a base material. The water-based dispersion including the zinc oxide particles is also added as the antibacterial agent. Furthermore, the dispersant and the defoamer are also added. Thus, the water-based slurry has a film-forming property and an antibacterial property. Furthermore, the protective film formed by the water-based slurry is waterproof, and has a good glossiness, oil resistance, wear resistance, and impact resistance (is strong in tension). Since water is the solvent in the water-based slurry, the water-based slurry does not have any VOC (volatile organic compounds) during solidification, so that the water-based slurry is safe and environmentally friendly.

In some embodiments, the water-based slurry further includes 0.1 parts to 5 parts of a water-soluble pigment by weight. The color of the protective film can be controlled by changing the type of the water-soluble pigment. In another embodiment, the water-based slurry includes 60 parts of the water-based polyurethane by weight, 1.5 parts of the dispersant by weight, 5 parts of the antibacterial agent by weight, 0.5 parts of the defoamer by weight, 1 part of the water-soluble pigment by weight, and 32 parts of the water by weight.

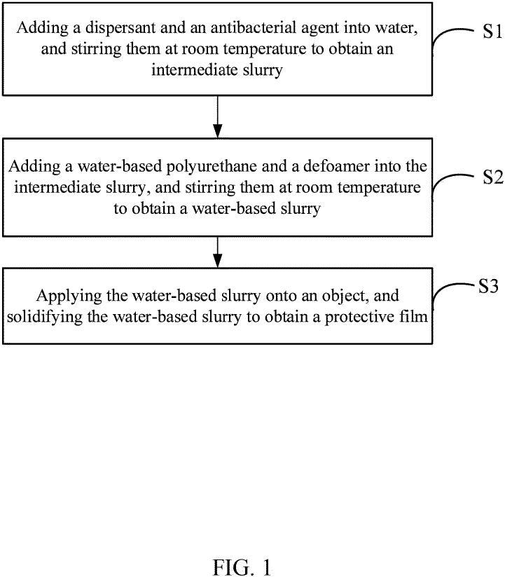

Referring to FIG. 1, a method for preparing a protective film is also presented in accordance with an embodiment. The method is provided by way of example, as there are a variety of ways to carry out the method. The method can begin at step S1.

S1, a dispersant and an antibacterial agent are added into water, and are stirred at room temperature to obtain an intermediate slurry.

In some embodiments, a stirring speed is 500 rpm/min to 1500 rpm/min, and a stirring period is 30 min to 60 min.

In some embodiments, a water-soluble pigment is also added into the intermediate slurry.

S2, a water-based polyurethane and a defoamer are added into the intermediate slurry, and are stirred at room temperature to obtain a final water-based slurry.

In some embodiments, a stirring period is 60 min to 80 min, and a stirring speed is 1000 rpm/min to 1200 rpm/min.

S3, the water-based slurry is applied to a surface, and solidified to obtain the protective film.

In some embodiments, a solidifying temperature is 60° C. to 80° C., and a solidifying period is 5 min to 10 min.

In some embodiments, a thickness of the protective film is 20 µm to 100 µm.

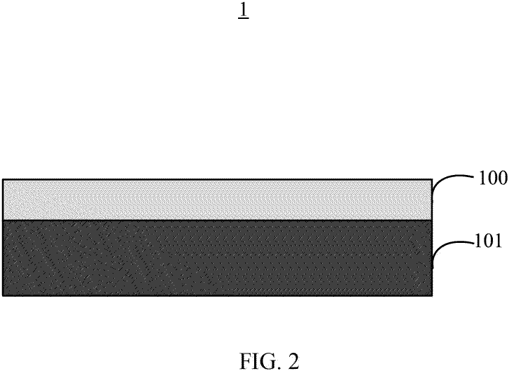

Referring to FIG. 2, a product 1 is also provided according to an embodiment of the present disclosure. The product 1 includes a main body 101 and a protective film 100 formed on the main body 101. The protective film 100 can be the protective film described above. The protective film 100 can be formed on the main body 101 by applying the water-based slurry on the main body 101 by spraying, immersion, or brushing, and then solidifying the water-based slurry. The thickness of the protective film 100 can be controlled, such as by spraying the water-based slurry on the main body 101 multiple times. The main body 101 may be door handle, elevator button, handle in public place, desk, computer button, nursing station equipment, wheelchair handle, stair handrail, hospital bed handrail, pull rings, and handrails in buses.

Since the water-based slurry can be applied on the main body 101 by spraying, immersing, or brushing, after solidification, the protective film 100 matches the surface of the main body 101 in shape. Thus, the protective film 100 can be applied an any surface topology, such as a concave, convex, or arc surface. The water-based slurry does not cause any damage to the main body 101.

The preparation method and the performance of the protective film will be further described in combination with specific examples and comparative examples. The following reagents are used in examples and comparative examples.
Water-based polyurethane: manufactured by Guoxin technology, WU-3021 (solid content of 30%, viscosity of 15 mPa· s to 100 mPa· s at 25° C., pH value of 8);
Dispersant: sodium hexametaphosphate, manufactured by Sanfu chemical;
Antibacterial agent: a water-based dispersion of zinc oxide particles, manufactured by Anfeng industry, WZnO-2110;
Defoamer: polyether modified silicone oil, manufactured by Anfeng industry, IOTA 1100;
Water-soluble pigment: phthalocyanine blue, manufactured by Colleen, Colanyl ®100.

### Example 1

S1, 1 part of the dispersant, 1 part of the antibacterial agent, and 27.5 parts of pure water were added into a mixer, and were stirred at room temperature by a speed of 1000 rpm/min for 45 min to obtain an intermediate slurry.

S2, 70 parts of the water-based polyurethane and 0.5 parts of the defoamer were added into the intermediate slurry, and were stirred at room temperature for 55 minutes to obtain a water-based slurry.

S3, the water-based slurry was applied on an object by spraying, cooled in cool air for 5 minutes, and heated at 80° C. for 5 minutes. After heating, the water-based slurry was left standing at room temperature for 5 minutes to obtain a protective film with a thickness of 22.4 µm.

### Example 2

S1, 1.5 parts of the dispersant, 5 parts of the antibacterial agent, and 32 parts of pure water were added into a mixer, and were stirred at room temperature by a speed of 1000 rpm/min for 45 min to obtain an intermediate slurry.

S2, 60 parts of the water-based polyurethane and 0.5 parts of the defoamer were added into the intermediate slurry, and were stirred at room temperature for 55 minutes. Then, 1 part of the water-soluble pigment was further added into the intermediate slurry, and was stirred at room temperature for 30 minutes. The water-soluble pigment was then finely ground with a three-wheel grinder to obtain a good coloring effect. Thus, a water-based slurry was obtained.

S3, the water-based slurry was applied on an object by spraying, cooled in cool air for 5 minutes, and heated at 80° C. for 5 minutes. After heating, the water-based slurry was left standing at room temperature for 5 minutes to obtain a protective film with a thickness of 22.4 µm.

### Example 3

S1, 1.5 parts of the dispersant, 9 parts of the antibacterial agent, and 9 parts of pure water were added into a mixer, and were stirred at room temperature by a speed of 1000 rpm/min for 45 min to obtain an intermediate slurry.

S2, 80 parts of the water-based polyurethane and 0.5 parts of the defoamer were added into the intermediate slurry, and were stirred at room temperature for 55 minutes to obtain a water-based slurry.

S3, the water-based slurry was applied on an object by spraying, cooled in cool air for 5 minutes, and heated at 80° C. for 5 minutes. After heating, the water-based slurry was left standing at room temperature for 5 minutes to obtain a protective film with a thickness of 22.4 µm.

### Comparative Example 1

S1, 1.5 parts of the dispersant, 11 parts of the antibacterial agent, and 28 parts of pure water were added into a mixer, and were stirred at room temperature by a speed of 1000 rpm/min for 45 min to obtain an intermediate slurry.

S2, 60 parts of the water-based polyurethane and 0.5 parts of the defoamer were added into the intermediate slurry, and were stirred at room temperature for 55 minutes to obtain a water-based slurry.

S3, the water-based slurry was applied on an object by spraying, cooled in cool air for 5 minutes, and heated at 80° C. for 5 minutes. After heating, the water-based slurry was left standing at room temperature for 5 minutes, but did not form a protective film.

### Comparative Example 2

S1, 1.5 parts of the dispersant, 0.5 parts of the antibacterial agent, and 18 parts of pure water were added into a mixer, and were stirred at room temperature by a speed of 1000 rpm/min for 45 min to obtain an intermediate slurry.

S2, 80 parts of the water-based polyurethane and 0.5 parts of the defoamer were added into the intermediate slurry, and were stirred at room temperature for 55 minutes to obtain a water-based slurry.

S3, the water-based slurry was applied on an object by spraying, cooled in cool air for 5 minutes, and heated at 80° C. for 5 minutes. After heating, the water-based slurry was left standing at room temperature for 5 minutes to obtain a protective film with a thickness of 22.4 µm.

The formulas in examples 1-3 and comparative examples 1-2 are shown in Table 1.

TABLE 1

| | Exa. 1 (part) | Exa. 2 (part) | Exa. 3(part) | Com. Exa. 1 (part) | Com. Exa. 2 part) |
|---|---|---|---|---|---|
| Water-based polyurethane | 70 | 60 | 80 | 60 | 80 |
| Dispersant | 1 | 1.5 | 1.5 | 1.5 | 1 |
| Antibacterial agent | 1 | 5 | 9 | 11 | 0.5 |
| Water-soluble pigment | 0 | 1 | 0 | 0 | 0 |
| Defoamer | 0.5 | 0.5 | 0.5 | 0.5 | 0.5 |
| Water | 27.5 | 32 | 9 | 28 | 18 |

The properties of the protective films in examples 1-3 and comparative examples 1-2 were tested, and the tested results are shown in Table 2. The properties to be tested include the antibacterial property, the impact resistance, the wear resistance (RCA), and glossiness.

The antibacterial property is tested according to Japanese Industrial Standard JIS Z 2801-2010 (International Standard ISO 22196-2011). The strain number of Staphylococcus aureus is BCRC 10451, and the strain number of Escherichia coli is BCRC 11634. The protective film acts on the Staphylococcus aureus or the Escherichia coli for 24 h. When the antibacterial value (R) ≥ 2, the antibacterial effect is achieved.

The impact resistance is tested by a falling ball impact tester (HV-0105) according to CNS 10757-1995 test standard. The diameter of the impact head is 25.4 mm, the test load is 300 g, and the test height is 300 mm.

The wear resistance is tested by a wear resistance tester (NORMAN, 7-IBB). The test load is 55 g, and the cycle is 100 times.

The glossiness is tested by a micro-TRI-gloss meter (BYK, 4446) according to ASTM D52Mar. 14, 2018 test standard. The test firing angle is 60°.

TABLE 2

| | | Exa. 1 (part) | Exa. 2 (part) | Exa. 3 (part) | Com. Exa. 1 (part) | Com. Exa. 2 (part) |
|---|---|---|---|---|---|---|
| antibacterial value (R) | Staphylococcus aureus | >3.86 | 4.31 | / | / | / |
| | Escherichia coli | / | 5.94 | >6.34 | / | 0.75 |
| Dispersing property | | + | + | + | - | + |
| Appearance | | Transparent | Blue | Transparent | Transparent | Transparent |
| Impact resistance | | No cracking, and the film is not peeled off | | | / | No cracking, and the film is not peeled off |
| Wear resistance | | The film is not worn off to expose the object | | | / | The film is not worn off to expose the object |
| Glossiness | | 69 | / | / | / | / |

Note: for the dispersing property in Table 2, “+” indicates dispersible or a good dispersibility in the intermediate slurry, and “-” indicates non-dispersible or a poor dispersibility in the intermediate slurry.

As shown in Table 2, the protective films in examples 1-3 have improved antibacterial property. The antibacterial value (R) against Staphylococcus aureus and Escherichia coli is greater than 2, and the protective films have antibacterial activity not less than 99%. The impact resistance, the wear resistance, and the glossiness are also good. In Comparative Example 1, the quantity of the antibacterial agent is too much, so the dispersing property of the dispersant is poor, which affects the film-forming property. In Comparative Example 2, the quantity of the antibacterial agent is too small, and the antibacterial property of the protective film is poor.

The above descriptions are some specific embodiments of the present application, but the actual application process cannot be limited only to these embodiments. For those of ordinary skill in the art, other modifications and changes made according to the technical concept of the present application should all belong within the protection scope of the present application.

What is claimed is:

1. A protective film with an antibacterial property, wherein:
the protective film is formed by solidifying a water-based slurry, the water-based slurry comprises:
60 parts to 80 parts by weight of a water-based polyurethane, the water-based polyurethane is a first dispersion of anionic aliphatic water-based polyurethane;
1 part to 1.5 parts by weight of a dispersant;
1 part to 10 parts by weight of an antibacterial agent, the antibacterial agent is a second dispersion of nano-sized zinc oxide particles;
0.5 parts by weight of a defoamer; and
9 parts to 32 parts by weight of water.

2. The protective film of claim 1, wherein a relative molecular weight of the water-based polyurethane is 10000 to 30000.

3. The protective film of claim 1, wherein a concentration of the nano-sized zinc oxide particles in the second dispersion is 25000 ppm, and an average particle size of the nano-sized zinc oxide particles is 5 nm to 10 nm.

4. The protective film of claim 1, wherein the dispersant is sodium hexametaphosphate.

5. The protective film of claim 1, wherein the defoamer is polyether modified silicone oil.

6. The protective film of claim 1, wherein the water-based slurry further comprises 0.1 parts to 5 parts by weight of a water-soluble pigment.

7. A method for preparing a protective film with an antibacterial property, comprising:
adding and dispersing a dispersant and an antibacterial agent in water at room temperature to obtain an intermediate slurry, wherein the antibacterial agent is a second dispersion of nano-sized zinc oxide particles;
adding and dispersing a water-based polyurethane and a defoamer in the intermediate slurry at room temperature to obtain a water-based slurry, wherein the water-based polyurethane is a first dispersion of anionic aliphatic water-based polyurethane, the water-based slurry comprises 60 parts to 80 parts by weight of the water-based polyurethane, 1 part to 1.5 parts by weight of the dispersant, 1 part to 10 parts by weight of the antibacterial agent, 0.5 parts by weight of the defoamer of, and 9 parts to 32 parts by weight of the water; and
solidifying the water-based slurry to obtain the protective film.

8. The method of claim 7, wherein the dispersant and the antibacterial agent are dispersed at a speed of 500-1500 rpm/min for a period of 30 min to 60 min; the water-based polyurethane and the defoamer are dispersed for a period of 60 min to 80 min.

9. The method of claim 7, wherein the water-based slurry is solidified at a temperature of 60° C. to 80° C. for a period of 5 min to 10 min.

10. The method of claim 7, further comprising:
adding and dispersing a water-soluble pigment in the intermediate slurry to obtain the water-based slurry, wherein the water-based slurry further comprises 0.1 parts to 5 parts of the water-soluble pigment by weight.

11. A product comprising:
a main body; and
a protective film with an antibacterial property formed on the main body, wherein the protective film is formed by solidifying a water-based slurry, the water-based slurry comprises:
60 parts to 80 parts by weight of a water-based polyurethane, the water-based polyurethane is a first dispersion of anionic aliphatic water-based polyurethane;
1 part to 1.5 parts by weight of a dispersant;
1 part to 10 parts by weight of an antibacterial agent, the antibacterial agent is a second dispersion of nano-sized zinc oxide particles;
0.5 parts by weight of a defoamer; and
9 parts to 32 parts by weight of water.
